(19) United States
(12) Patent Application Publication
(10) Pub. No.: US 2006/0284996 A1
(43) Pub. Date: Dec. 21, 2006

(54) Image capture device, image capture system, and synchronizing method

(76) Inventors: Kunihiko Kanai, Nagano (JP); Shuji Asami, Shizuoka (JP); Masao Kobayashi, Nagano (JP)

Correspondence Address: Pamela R. Crocker;Patent Legal Staff, Eastman Kodak Company, 343 State Street, Rochester, NY, 14650-2201, US

(21) Appl. No.: 11/360,214

(22) Filed: Feb. 23, 2006

(30) Foreign Application Priority Data
Jun. 20, 2005 (JP) 2005-178729

(51) Int. Cl. H04N 5/335

(52) U.S. Cl. 348/294

(57) ABSTRACT

Image capture devices are synchronized without using a communication unit for an image capture device to perform communication with other image capture device. When an image capture device 10 is set to the main device mode, it outputs a reset signal to a timing generator 40 simultaneously with the time when a flash circuit 50 performs pre-light emission and, when the image capture device 10 is set to the auxiliary device mode, the flash circuit 50 detects pre-light emission performed by other image capture device and outputs a reset signal to the timing generator 40 in accordance with the detection of the pre-light emission.

### FIELD OF THE INVENTION The present invention relates to the synchronization of image capture devices in an image capture system using image capture devices.

### BACKGROUND OF THE INVENTION

Image capture systems using image capture devices are disclosed in Japanese Patent Laid-Open Publication No. 2004-048648, which discloses a system that generates special effect images, such as a stereoscopic or panoramic image, using image capture devices; and Japanese Patent Laid-Open Publication No. 2004-235786, which discloses a system set so as to light-emit only a stroboscope in accordance with a brightness illuminated to an object at the time of collaboration photographing connecting digital cameras and using a stroboscope or set so as to emit light by decreasing the stroboscope light emission quantity of each camera. It is a system in which one camera performs image capturing while the other camera emits a strobe flash, or one of a plurality of cameras performs image capturing with each of the cameras emitting a small amount of strobe flash.

In the case of an image capture system using image capture devices, when a special effect image such as stereoscopic or panoramic image is generated, a true image cannot be obtained unless image capture devices are accurately synchronized. Moreover, when multiple image capture devices are used to simultaneous capture an image using a flash, it is necessary to consider not only synchronization of exposure periods, but also synchronization of flash emission.

In consideration of this necessity, techniques for synchronization of image capture devices in an capture system as outlined above are disclosed in Japanese Patent Laid-Open Publications No. 2002-247408, and 2003-304442. In the system described in JP 2002-247408, a master camera generates a time stamp that synchronizes flame sync signals of all of the involved image capture devices including the master camera), and the image capture devices generate frame sync signals in accordance with the time stamp generated by the master camera and then generate image data in accordance with the generated frame sync signals.

Meanwhile, the communication system disclosed in JP 2003-304442, comprises transmitters and a receiver that receives signals from the transmitters, wherein the transmitters transmit the signals on the basis of the sync signal received from the receiver and the receiver transmits the sync signal and performs processing by using the signals received by the transmitters on the basis of the sync signal. However, although capture devices can be synchronized in accordance with the above-described art, for image capture devices to synchronize with other image capture devices, it is necessary that each employs a communication unit that communicates with the other image capture devices.

### SUMMARY OF THE INVENTION

The present invention advantageously enable synchronization among image capture devices without requiring a communication unit for one image capture device to communicate with another.

An image capture system of the present invention is constituted by two or more image capture devices each having a timing generator for outputting a sync signal and a control circuit for controlling an exposure period in accordance with the synch signal, in which one image capture device functions as a main device and the other image capture device functions as an auxiliary device. The main device comprises a flash circuit that applies pre-light emission of a small light quantity to an object before main light emission when an image capturing operation is begun and a reset circuit for outputting a reset signal to the timing generator of the reset circuit in accordance with the pre-light emission to adjust the output timing of the sync signal and the auxiliary device includes a detection circuit for detecting pre-light emission to be performed by the main device toward the object and a reset circuit for outputting a reset signal to the timing generator of the reset circuit in accordance with the detection of pre-light emission to adjust the output timing of the sync signal, and sync signals output by the timing generators of the image capture devices are synchronized.

According to the present invention, a main device performs pre-light emission, outputs a reset signal to a timing generator of the main device in accordance with the pre-light emission, and adjusts the output timing of a sync signal while an auxiliary device detects pre-light emission by the main device, outputs a reset signal to the timing generator of the auxiliary device in accordance with the detection of pre-light emission, and adjusts the output timing of a sync signal. Thereby, the devices can be synchronized without providing a communication unit that is used to communicate with other devices.

Moreover, an image capture device of the present invention includes a flash circuit that emits flash light. The flash circuit includes a luminance detection circuit that detects the luminance of the object, light quantity calculation circuit that calculates the light quantity of the flash light to be applied to the object on the basis of the detected luminance of the object, and a light-emission stop circuit that halts the light emission of the flash light when the calculated light quantity reaches a threshold value at which the calculated light quantity will result in the proper exposure. The detection circuit detects the luminance change of the object in accordance with the luminance of the object to be detected by the luminance detection circuit.

According to the present invention, the detection circuit can detect the luminance change of the object in accordance with the luminance of the object to be detected by the luminance detection circuit of the flash circuit. As a result, it is possible to avoid the costs required to provide an additional circuit to an image capture device.

### BRIEF DESCRIPTION OF THE DRAWINGS

FIG. 1 is an illustration showing a schematic configuration of an image capture system according to an embodiment of the present invention;

FIG. 2 is an illustration showing a functional block of the image capture device of the preferred embodiment;

FIG. 3 is an illustration showing a detailed functional block of a flash circuit;

FIG. 4 is an illustration showing the time change of the detection voltage value Vₚ from prior to until after flash emission;

FIG. 5A is a circuit block diagram of a luminance detection circuit, which is an illustration showing the state of the luminance detection circuit in the automatic photochromic mode;

FIG. 5B is a circuit block diagram of the luminance detection circuit showing the state of the luminance detection circuit in the reset signal output mode;

FIG. 6A is a flowchart showing the processing steps in an image capture device set to the main device mode;

FIG. 6B is a flowchart showing the processing steps in an image capture device set to the auxiliary device mode;

FIG. 7 is an illustration showing the timing chart of an image capture device performing simultaneous photography without emitting a flash;

FIG. 8A is a timing chart when an image capture device set to the main device mode emits a flash to perform simultaneous photography;

FIG. 8B is a timing chart when an image capture device set to the auxiliary device mode emits a flash to perform simultaneous photography;

FIG. 9 is an illustration showing photographing operation conditions of an image capture device [n] operating in the sequential photographing mode;

FIG. 10 is an illustration showing a timing chart of an image capture device operating in the sequential photographing mode;

FIG. 11 is a flowchart illustrating the processing of an image capture device operating in the synchronous photographing mode; and

FIG. 12 is a flowchart illustrating the processing of an image capture device operating in the simultaneous continuous flash photographing mode.

### DETAILED DESCRIPTION OF THE INVENTION

A preferred embodiment of the present invention is described below while referring to the accompanying drawings.

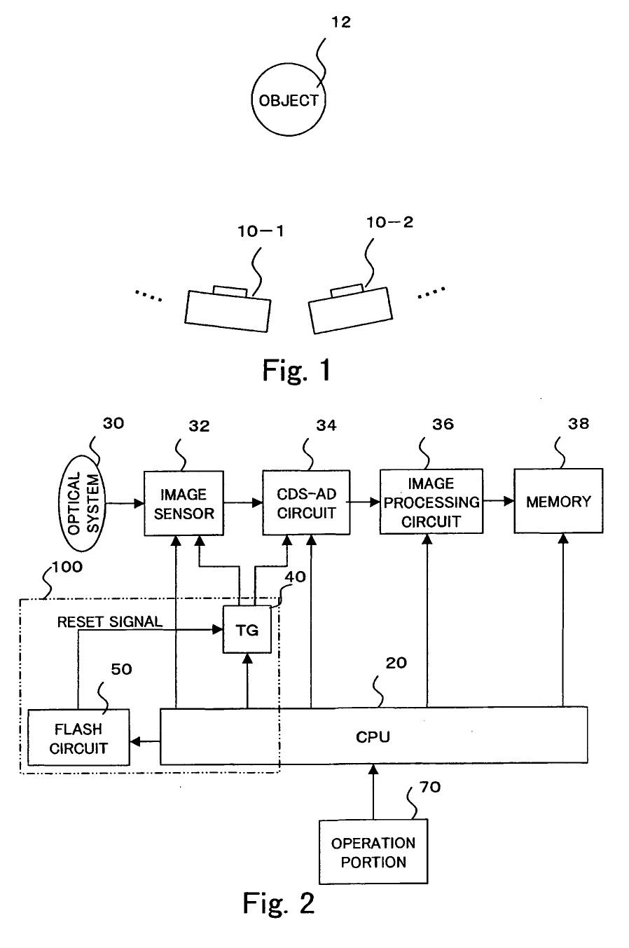

FIG. 1 is an illustration showing a schematic configuration of the image capture system of the present embodiment. As shown in FIG. 1, this image capture system comprises a plurality of image capture devices 10-1, 10-2, (hereafter generally referred to as “image capture device 10” when differentiation is unnecessary. This system is similarly applied to a circuit constituting the image capture device 10). Each image capture device 10 is synchronized to perform simultaneous or continuous photography for capturing an image of an object 12.

In the example of this embodiment, each image capture device 10 can operate in either of two modes, such as a main device mode and an auxiliary device mode. The image capture device 10 set to the main device mode performs pre-light emission and the image capture device 10 set to the auxiliary device mode detects the pre-light emission and synchronizes image capture devices at the detection timing. With such a configuration, the pre-light emission denotes light emission of a small quantity of light prior to main light emission in order to ensure proper exposure when the image is captured. This is a general function of an image capture device commonly executed when performing red-eye prevention, but, in the example of this embodiment, the pre-light emission is used as a trigger to realize synchronization in an image capture period without providing a special communication unit to each image capture device 10.

A configuration of each image capture device 10 is described below. FIG. 2 is an illustration showing a functional block diagram of each image capture device 10 constituting the image capture system of this embodiment. In this embodiment, a digital still camera is described as an example of the image capture device 10, but it is also possible to use another imaging device, such as a film camera, as the device for capturing an image of an object.

In FIG. 2, a CPU 20 is a central processing unit for performing overall control of the image capture device 10 and performs processing and control for each circuit constituting the image capture device 10. An optical system 30 includes a lens and a diaphragm to direct the light from an object to enter an image sensor 32 so that a desired video signal can be obtained. The image sensor 32 includes a solid-state image capture element such as a CCD or CMOS that vertically and horizontally transfers a vide signal generated by photoelectric-converting incoming light and outputs the video signal to a CDS (Correlated Double Sampling)-AD (Analog/Digital) circuit 34. The CDS-AD circuit 34 reduces noise of a video signal output from the image sensor 32 through correlation double sampling processing and converts the video signal into a digital signal. An image processing circuit 36 applies predetermined image processing to the video signal output from the CDS-AD circuit 34 and stores video signals for one frame in a memory 38 as image data.

A timing generator (TG) 40 outputs a horizontal sync signal (HD) and vertical sync signal (VD) required to drive a solid-state image capture element included in the image sensor 32 and a sync signal required for the CDS-AD circuit 34 to process signals and synchronizes the image sensor 32 and CDS-AD circuit 34. A flash circuit 50 emits a small quantity of light toward an object at the time of pre-light emission and light toward the object so that proper exposure is realized at the time of photography. In the example of the present embodiment, the flash circuit 50 further outputs a reset signal for adjusting the output timing of each sync signal output from the timing generator 40 to the timing generator 40. In the configuration employed in the present embodiment, image capture devices are synchronized when the flash circuit 50 outputs a reset signal to the timing generator 40. An operation portion 70 is a user interface for a user to operate the image capture device 10 such as a shutter button which can be either partially or fully depressed.

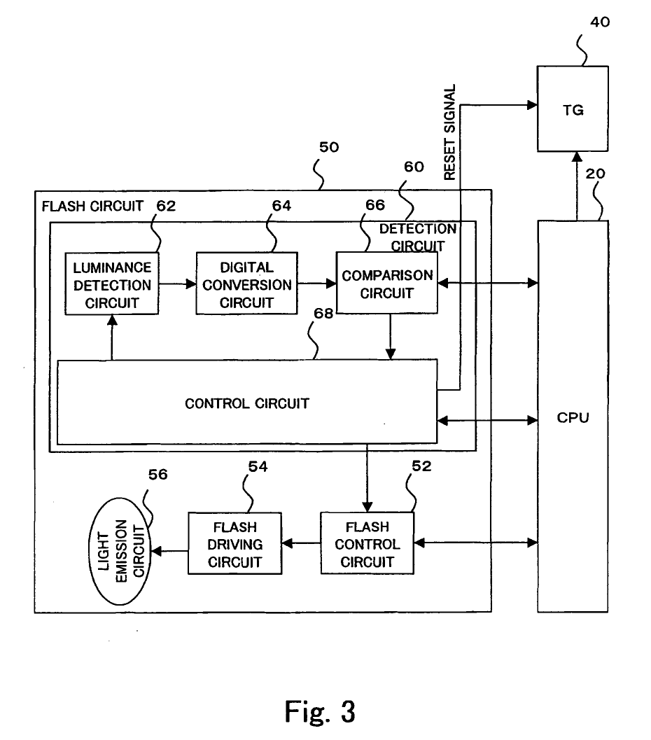

The flash circuit 50 is described in more detail below by referring to FIG. 3. FIG. 3 is an illustration showing the dotted line portion 100 shown in FIG. 2, particularly a detailed functional block for the flash circuit 50. In FIG. 3, a flash control circuit 52 outputs a light-emission command to a flash driving circuit 54 in accordance with a light-emission control command from the CPU 20. The flash driving circuit 54 drives a light-emission circuit 56 in accordance with a light-emission command and the light emission circuit 56 emits an amount light corresponding to the light-emission command.

Moreover, a detection circuit 60 includes a luminance detection circuit 62, digital conversion circuit 64, comparison circuit 66, and control circuit 68. The luminance detection circuit 62 has a light receiving device and the light receiving device receives the light reflected by an object and outputs a photoelectric current corresponding to the received light quantity. Furthermore, the luminance detection circuit 62 outputs the voltage of a detection voltage value Vₚ corresponding to the photoelectric current output from the light receiving device. The light receiving device of the detection circuit 60 may also serve as, for example, a light receiving device in a camera housing included in the publicly-known TTL automatic photochromic mechanism. Furthermore, it is possible to place a light-receiving device dedicated to the detection circuit 60 near the light receiving device of the TTL automatic photochromic mechanism. Furthermore, when the flash circuit 50 is an external stroboscope, it is possible to set the light receiving device to the external stroboscope. Though the digital conversion circuit 64 is a circuit that converts a detection voltage value from the luminance detection circuit 62 into a digital value, it is possible to constitute the circuit 64 by an analog circuit. With such a configuration, there is a method of setting a D/A converter in the CPU 20 and setting a threshold value to the comparison circuit 66 as an analog value. In the configuration of the present embodiment, a configuration using high-speed digital conversion is described.

Furthermore, in FIG. 3, the digital conversion circuit 64 converts the detection voltage value Vₚ of the voltage output from the luminance detection circuit 62 into a digital signal. The comparison circuit 66 compares the detection voltage value Vₚ with a predetermined threshold voltage and outputs the comparison result to the control circuit 68. The control circuit 68 outputs a predetermined command to the luminance detection circuit 62 or flash control circuit 52. Moreover, the control circuit 68 outputs a reset signal to the timing generator 40 at a predetermined timing.

The detection circuit 60 thus constituted has an automatic photochromic mode that adjusts the light quantity of a flash and reset signal output mode that outputs a reset signal in accordance with detection of pre-light emission by other image capture device and performs a different operation in each mode. Therefore, operations of the detection circuit 60 are further described for each mode.

First, in the automatic photochromic mode, the detection circuit 60 outputs a flash emission stop command to the flash control circuit 52 once a sufficient amount of light for main light emission or pre-light emission has been emitted to an object. More specifically, a proper voltage value V_{T} supplied from the CPU 20 is pre-stored in the comparison circuit 66. Here, the proper voltage value V_{T} is a voltage value determined in accordance with the light quantity to be supplied to an object at the time of main light emission or pre-light emission.

Thereafter, when a flash is use to illuminate to the object, the luminance detection circuit 62 outputs the voltage of the detection voltage value Vₚ corresponding to the light quantity of the flash light. The digital conversion circuit 64 converts an analog signal showing the detection voltage value Vₚ of the voltage output from the luminance detection circuit 62 into a digital signal and outputs the digital signal to the comparison circuit 66. The comparison circuit 66 compares the proper voltage value V_{T} with the detection voltage value Vₚ and when the latter reaches the former, outputs a light-emission completion notice to the control circuit 68. The control circuit 68 receives the light-emission completion notice and outputs a flash emission stop command to the flash control circuit 52. Thereby, the flash circuit 50 can halt flash emission once a desired light quantity has been output to an object and proper exposure can be obtained.

However, in the reset signal output mode, the detection circuit 60 monitors the luminance change of the object and, when the luminance of the object becomes a predetermined threshold luminance or higher, determines that light from pre-light emission is being applied to the object from another image capture device and outputs a reset signal to the timing generator 40. More specifically, the luminance detection circuit 62 first outputs a voltage corresponding to the luminance of the object before flash emission and the digital conversion circuit 64 converts an analog signal showing the detection voltage value Vₚ of the voltage output from the luminance detection circuit 62 into a digital signal and outputs the digital signal to the comparison circuit 66. The comparison circuit 66 obtains and stores a threshold voltage value Vₛ from the detection voltage value Vₚ. Here, the threshold voltage value Vₛ shows a voltage value corresponding to the above threshold luminance. For example, the detection voltage value Vₚ is monitored for a predetermined period and used as a voltage value obtained by adding a predetermined value (for example, value corresponding to light quantity of pre-light emission) to the average value during the period or by adding a predetermined value to the maximum value in the period.

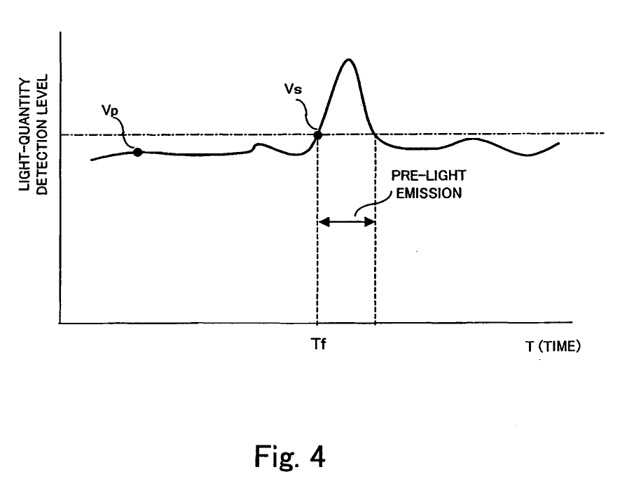

The purpose for obtaining the threshold voltage value Vs by adding a predetermined value to the average value or maximum value will next be described by referring to FIG. 4. FIG. 4 is an illustration showing the change of detection voltage value Vₚ from before flash emission until after flash emission. As shown in FIG. 4, although the detection voltage value Vₚ before pre-light emission (in FIG. 4, before time Tf) is comparatively stable, the luminance of the object has a slight fluctuation due to influence of noise or the like. Therefore, to prevent the comparison circuit 66 from erroneously determining that the change of the luminance of the object due to the influence is a change due to flash emission, the comparison circuit 66 stores a voltage value obtained by adding a predetermined value to the average value in a predetermined period before pre-light emission or a voltage value obtained by adding a predetermined value to the maximum value in the period as the threshold voltage value Vₛ.

As described above, when the threshold voltage value Vₛ is obtained and then the detection voltage value Vₚ output from the luminance detection circuit 62 becomes the threshold voltage value Vₛ or higher, the comparison circuit 66 determines that flash light is applied to the object and outputs a light emission notice to the control circuit 68. The control circuit 68 receives the light emission notice and outputs a reset signal to the timing generator 40. Thereby, the timing generator 40 receives the reset signal in accordance with the pre-emission to the object and can adjust the output timing of each sync signal such as a vertical sync signal. Therefore, for example, when one image capture device performs pre-light emission, each image capture device 10 outputs a reset signal to the timing generator 40 of its own and thereby, image capture devices can be synchronized. For the unit for determining that flash is applied to an object, it is possible to use a technique of providing a filter circuit for the luminance detection circuit 62, the digital conversion circuit 64, and the comparison circuit 66 detecting a change value of brightness as a differential value and corresponding to a steep change.

When an image capture device is set to the main device mode, the detection circuit 60 outputs a reset signal to the timing generator 40 in accordance with the pre-light emission by the device. More specifically, the CPU 20 outputs a pre-light emission control command to the flash control circuit 52 while simultaneously outputting a pre-light emission command notice to the control circuit 68. Moreover, the flash control circuit 52 controls the flash driving circuit 54 in accordance with the pre-light emission control command and thereby, the light emission circuit 56 emits light for pre-light emission while the control circuit 68 simultaneously outputs a reset signal to the timing generator 40 in accordance with the light-emission command notice. Thereafter, the control circuit 68 performs the above automatic photochromic-mode processing, receives the light-emission completion notice when the light quantity necessary for pre-light emission is emitted to an object, and outputs a flash emission stop command to the flash control circuit 52.

Moreover, when the image capture device is set to the auxiliary device mode, the detection circuit 60 first operates in the above-described reset signal output mode, detects pre-light emission of the main device, and outputs a reset signal to the timing generator 40. Furthermore, when a flash automatic photochromic function is selected, the detection circuit 60 outputs the reset signal and then it is changed to the automatic photochromic mode.

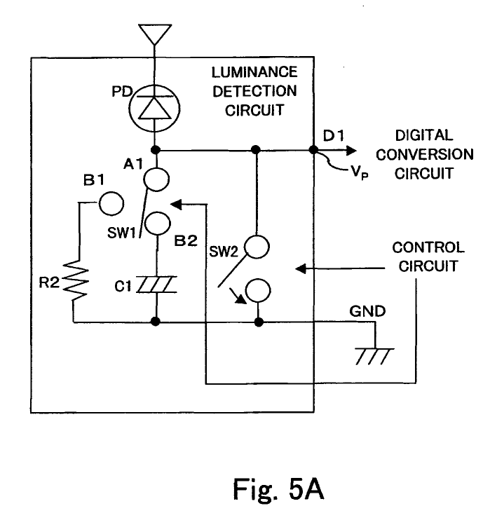

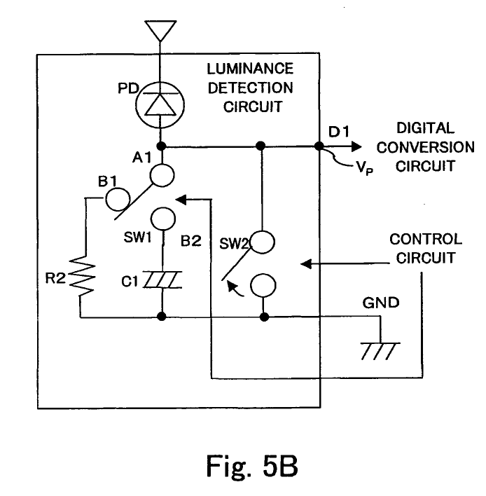

The luminance detection circuit 62 is further described below by referring to FIGS. 5A and 5B. FIGS. 5A and 5B are circuit block diagrams of the luminance detection circuit 62, in which FIG. 5A shows a state of the luminance detection circuit 62 in the automatic photochromic mode and FIG. 5B shows a state of the luminance detection circuit 62 in the reset signal mode.

As shown in FIGS. 5A and 5B, the luminance detection circuit 62 includes a photodiode PD as a light receiving device which outputs photoelectric current corresponding to the light quantity of the light received from an object. The anode terminal of the photodiode PD is connected to the common contact point A1 of a changeover switch SW1. The changeover switch SW1 has two changeover contact points B1 and B2 and allows changeover of two states such as a state of closing contact points A1 and B1 and a state of closing contact points A1 and B2. This changeover is performed in accordance with a changeover signal from the control circuit 68. The changeover contact point B1 of the changeover switch SW1 is connected to the ground (GND) through a resistance R2 and the changeover contact point B2 is connected to the ground through a capacitor C1. Moreover, the anode terminal of the photodiode PD is connected to the ground through an ON/OFF switch SW2 set in parallel with the changeover switch SW1 (and resistance R2 and capacitor C1). The switch SW2 is turned on/off in accordance with an ON/OFF signal from the control circuit 68. Moreover, in this circuit configuration, the voltage of the anode terminal of the photodiode PD is output to the digital conversion circuit 64 from the output terminal D1. Operations of the luminance detection circuit 62 thus constituted are further described below.

First, as shown in FIG. 5A, in the automatic photochromic mode, when receiving a flash emission command in which the light quantity corresponding to main light emission or pre-light emission is designated from the CPU 20, the control circuit 68 connects the common contact point A1 of the changeover switch SW1 to the changeover contact point B2 and turns on the ON/OFF switch SW2. Then, the detection voltage value Vₚ is initialized up to the GND level. Then, when the control circuit 68 receives the flash emission command and at the same time turns off the ON/OFF switch SW2, the light from an object is photoelectric-converted by the photodiode PD and obtained electric charges are accumulated in the capacitor C1. Thereby, the detection voltage value Vₚ rises in accordance with the light quantity of the flash light applied to the object. Moreover, when the detection voltage value Vₚ rises to the proper voltage value V_{T} showing a voltage value for proper exposure, the comparison circuit 66 outputs a flash emission stop command.

However, as shown in FIG. 5B, in the reset signal output mode, the control circuit 68 connects the common contact point A1 of the changeover switch SW1 to the changeover contact point B1 and turns off the ON/OFF switch SW2. Then, the detection voltage value VP rises to a voltage corresponding to the luminance of the present object. Then, the comparison circuit 66 obtains and stores the threshold voltage value Vₛ. Thereafter, when the detection voltage value Vₚ exceeds the threshold voltage value Vₛ, the comparison circuit 66 determines that flash light is applied to the object and the control circuit 68 outputs a reset signal to the timing generator 40.

To illustrate the present embodiment, an example of using a light receiving device for the automatic photochromic mode and reset signal output mode is described. That is, an example was described in which the flash circuit 50 detects pre-light emission to an object by using a light receiving device prepared to adjust flash light quantity and outputs a reset signal. However, it is also possible to use a circuit having a light receiving device for detecting pre-light emission to an object without using the light receiving device of the flash circuit 50.

Therefore, the processing procedure of each image capture device when synchronous photography is performed in an image capture system according to the present embodiment will be described through an example in which different users perform shutter button operations of the image capture devices 10-1 and 10-2.

According to this example, a user first operates the image capture device 10-1, which enters the main device mode, to perform initialization necessary for synchronous photography, such as inputting the number of captured images and whether or not a flash is to be used and sets the image capture device 10-1 to a desired position. Moreover, the user operates the image capture device 10-2, which is placed in the auxiliary device mode, to perform initialization necessary for synchronous photography similarly to the case of the image capture device 10-1 and sets the image capture device 10-2 to a desired position. It is also possible that each of a multiple users holds one image capture device 10 in their hands. Moreover, it is still further possible to set the auxiliary device mode of the image capture device 10-2 via a network while setting the main device mode for the image capture device 10-1 when operating the image capture device 10-1 by setting a unit for performing wireless or wired communication with the image capture devices 10-1 and 10-2.

The image capture device 10-1 receives the main-device mode setting information input by the user and derives the light quantity of pre-light emission which becomes a trigger of the output of a reset signal on the basis of the luminance of the object. The image capture device 10-2 receives auxiliary-device mode settings input by the user and derives the threshold voltage value Vₛ necessary to detect light emitted during the pre-light emission by the image capture device 10-1 (that is, obtains the threshold voltage value Vₛ from the detection voltage value Vₚ). Thus, when initialization is completed and a first user partially depresses the shutter button of the image capture device 10-1 while a second user partially depresses the shutter button of the image capture device 10-2, each image capture device performs AE/AF (auto exposure/auto focus) and enters a synchronous-photography standby mode. Then, when the first user fully depresses the shutter button of the image capture device 10-1, synchronous photography with the image capture devices 10-1 and 10-2 begins. Hereafter, processing procedures of the image capture device 10-1 set to the main device mode and the image capture device 10-2 set to the auxiliary device mode are individually described.

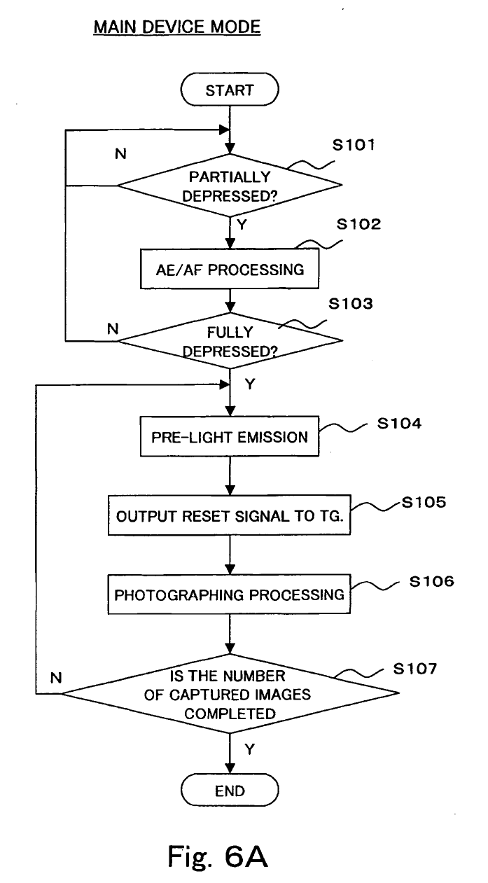

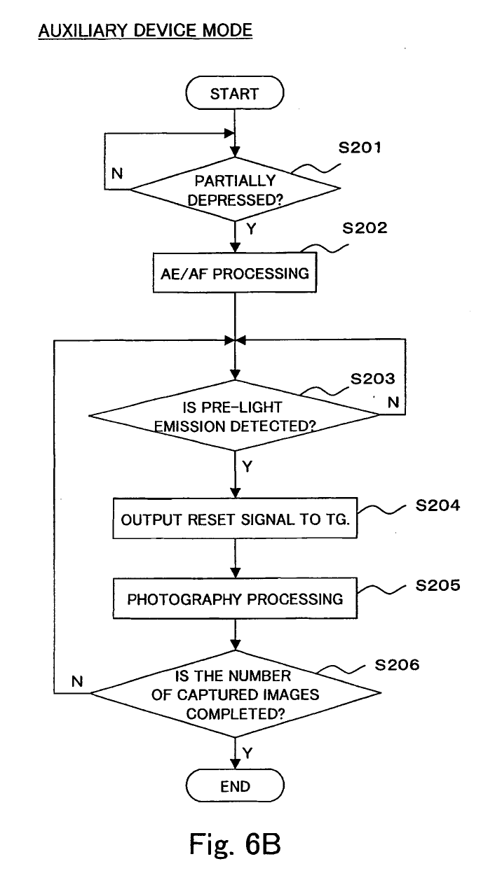

First, the processing steps of the image capture device 10-1 set to the main device mode will be described by referring to the flowchart shown in FIG. 6A.

When the shutter button of the image capture device 10-1 is partially depressed (determination result in S101 is affirmative “Y”), AE/AF processing is performed (S102). Then, the shutter button is fully depressed (determination result in S103 is affirmative “Y”), a flash circuit 50-1 emits light for pre-light emission (S104) and outputs a reset signal to a timing generator 40-1 at the same time as the pre-light emission (S105). Thereby, each sync signal such as vertical sync signal output from the timing generator 40-1 is reset. Then, the image capture device 10-1 executes predetermined processing synchronously with each sync signal output by the reset timing generator 40-1 (S106). When the initially-set number of images have not been captured, (determination result in S206 is negative “N”), processings from S203 are repeated and the photography processing in which image capture devices are synchronized is performed again. However, when the initially-set number of images have been captured (determination result in S107 is affirmative “Y”), the image capture device 10-1 completes synchronous photographing.

Then, the processing procedure of the image capture device 10-2 set to the auxiliary device mode is described by referring to the flowchart shown in FIG. 6B.

When the shutter button of the image capture device 10-2 is partially depressed (determination result in S201 is affirmative “Y”), the device 10-2 performs AE/AF (S202). Thereafter, the device 10-2 waits until the image capture device 10-1 performs pre-light emission. When pre-light emission is performed, a flash circuit 50-2 detects the pre-light emission (determination result in S203 is affirmative “Y”) and outputs a reset signal to a timing generator 40-2 (S204). Thereby, each sync signal output from the timing generator 40-2 is reset. The image capture device 10-2 executes predetermined photographing processing synchronously with each sync signal output from the reset timing generator 40-2 (S205). When capture of the initially-set number of captured images has not been completed, (determination result in S206 is negative “N”), processings from S203 are repeated and the photographing processing in which image capture devices are synchronized is performed again. However, when capture of the initially-set number of images has not been completed (determination result in S206 is affirmative “Y”), the image capture device 10-2 completes synchronous photography.

As described above, a reset signal is output nearly simultaneously to the timing generators 40-1 and 40-2 using pre-light emission as a trigger and the image capture devices 10-1 and 10-2 are synchronized. Therefore, video signals are output from solid-state image capture elements to the image capture devices 10-1 and 10-2 in accordance with synch signals output from the timing generators 40-1 and 40-2 which are synchronized. That is, the image capture devices 10-1 and 10-2 are able to generate a 3D image, measure the distance to an object, and generate a wide-range image, such as a panoramic image, in collaboration, without causing sync shift. It is also possible to set the image capture device set to the auxiliary device mode so that only photographing using detection of a pre-light emission as a trigger is possible and photography using full depression of the shutter button as a trigger is disabled. Thereby, it is possible to prevent a user of the image capture device set to the auxiliary device mode from disrupting image capturing by erroneously depressing the shutter button.

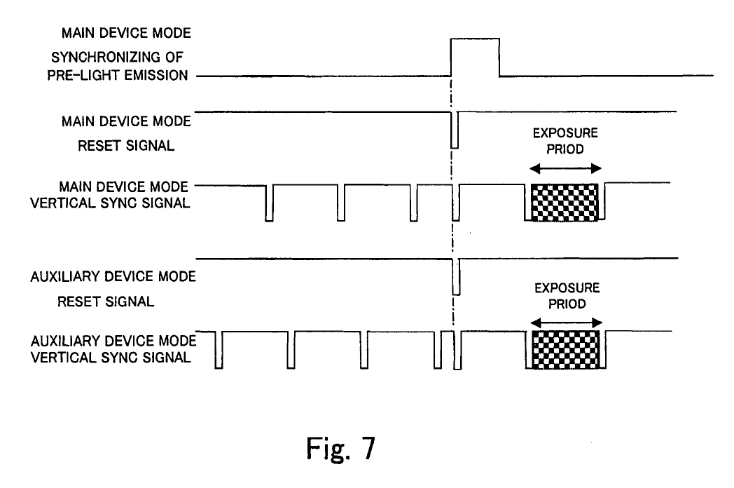

FIG. 7 is an illustration showing a timing chart when the image capture device 10-1 set to the main device mode and the image capture device 10-2 set to the auxiliary device mode are synchronized to perform simultaneous photography using pre-light emission performed by the image capture device 10-1 as a trigger. As shown in FIG. 7, according to this embodiment, a reset signal is simultaneously output to each timing generator 40 using pre-light emission as a trigger and vertical sync signals are synchronized with each other. Therefore, image capture devices can start and complete exposure at the same timing.

Moreover, according to this embodiment, because image capture devices are synchronized, when any image capture device set to the main device mode or auxiliary device mode performs flash emission for illuminating an object at the time of photographing, the remaining image capture devices which perform simultaneous photography can perform flash photography without performing flash emission because the object is illuminated by the flash emitted by one image capture device.

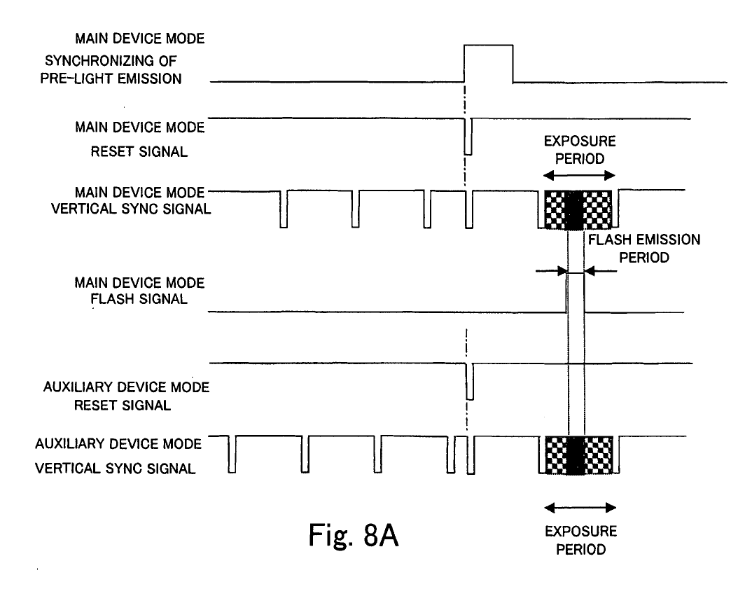

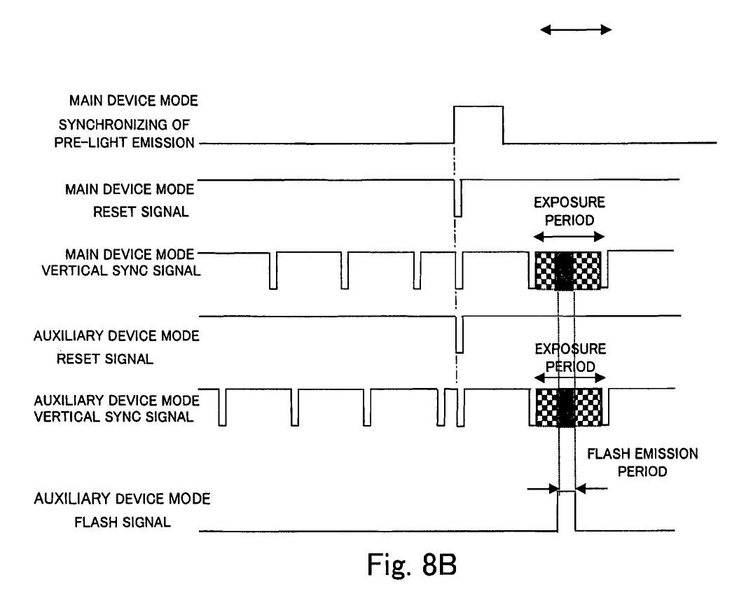

FIG. 8A is an illustration showing a timing chart when the image capture device 10-1 set to the main device mode emits a flash to perform photography while the image capture device 10-2 set to the auxiliary device mode simultaneously performs photography without performing flash emission and FIG. 8B is an illustration showing a timing chart when the image capture device 10-2 set to the auxiliary device mode emits a flash to perform photography.

As shown in FIGS. 8A and 8B, by employing a configuration according to the present embodiment, it is possible to perform flash photography using flash emission performed by another image capture device without performing flash emission by a first image capture device as long as any one of image capture devices performs flash emission. Thus, according to the present embodiment, because timing generators of image capture devices are synchronized with each other, it is possible to execute simultaneous photographing without causing sync shift when only one image capture device performs flash photography and other image capture devices simultaneously perform photography without emission of a flash.

Moreover, because, according to this embodiment, image capture devices are synchronized with each other, it is possible to easily realize that a plurality of image capture devices simultaneously perform flash emission and perform photography simultaneously. Thereby, because the amount of flash to be emitted to capture an image of an object can be dispersed among multiple image capture devices, it is possible to perform photography by setting the amount of light emitted by each image capture device to a slightly lower value and reduce the power consumption in each image capture device. For example, when the image capture devices 10-1 and 10-2 simultaneously perform flash emission to photograph the same object and it is assumed that the amount of flash emitted by the image capture device 10-1 is GN(M) and the amount of flash emitted by the image capture device 10-2 is GN(S), the total flash light quantity GN(T) can be represented by the Numerical Formula 1:
GN(T)=\sqrt{GN(M)²+GN(S)²}

Then, in the case of simultaneous image photography, because GN(M)≦GN(S), the power consumption in each image capture device is approximately 50% less than when flash is emitted by a single image capture, device, when difference in efficiency are not considered. Because each image capture device can decrease the charge quantity necessary for flash emission, it is possible to decrease the charge time of flash emission. Thereby, it is possible to decrease the time between images for continuous photography using flash emission.

Moreover, it is possible to simplify photographing of a single object at the same timing by using a different photographing parameter for each image capture device or to perform different image processing for each image capture device on the image data obtained by photographing the objects at the same time. Thereby, it is possible to easily synthesize a plurality of image data obtained by performing photography in different-length exposure periods at the same timing. Imaging parameters include not only the length of exposure period, but also conditions set before photography such as the amplification factor and white balance of a solid-state image capture element. Image processing includes edge emphasis and color reproduction. Moreover, because it is possible to perform the above-described manual processing through the AE/AF processing (S102 and S202) illustrated in FIGS. 6A and 6B, it is possible to easily change photography distances.

Furthermore, as a modification of this embodiment, by constructing a system so that the image capture device 10-2 performs AE/AF processing when it is set to the auxiliary device mode and becomes a standby mode for detecting pre-light emission, the image capture device 10-2 performs synchronous photography using the pre-light emission of the image capture device 10-1 as a trigger, even if a shutter button is not partially depressed. Thereby, a user can easily perform simultaneous photography using a plurality of image capture devices by operating only the image capture device 10-1.

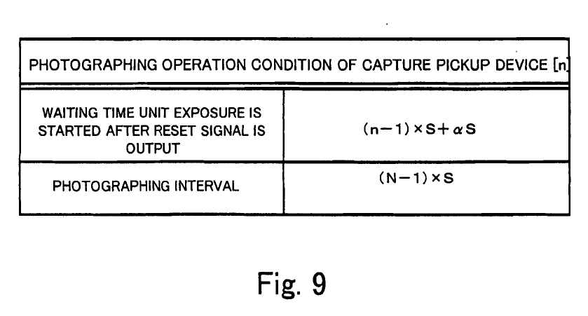

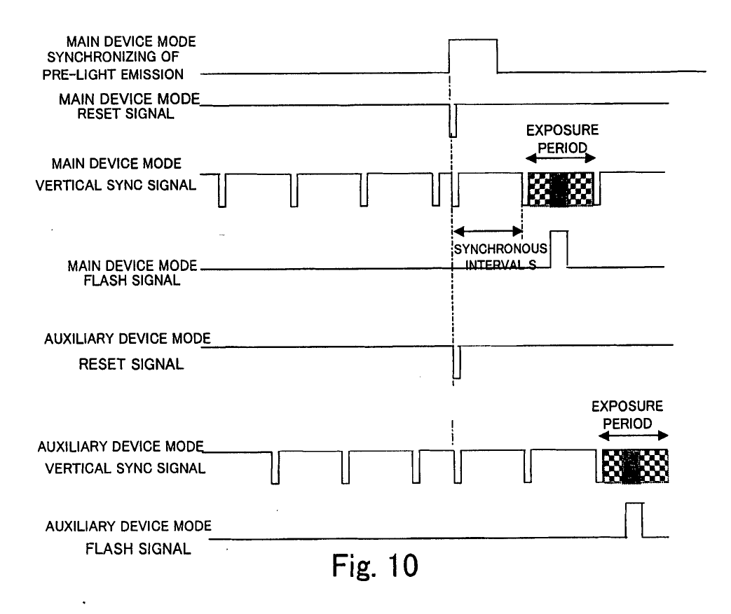

Furthermore, as another modification of the present embodiment, it is possible for image capture devices to easily realize sequential photography in order (hereafter referred to as sequential photographing mode). For example, when the image capture system of this embodiment is constituted of N image capture devices and the N image capture devices are numbered 1 to N, the n(integer)-th image capture device can be referred to as image capture device [n], and the period of the vertical sync signal of each image capture device can be labeled period interval S. Then, at the initialization of each image capture device, the photography operation conditions shown in FIG. 9 are set. By setting the conditions, the image capture device [n] pauses for a period (n−1)×S+αS (αis an integer set by considering the processing time until an image capture device can start exposure processing after outputting a reset signal) and exposure is performed in accordance with a vertical sync signal which is first reset by a reset signal. After the exposure is completed, the image capture device [n] pauses for a period (N−1)×S and further performs exposure. By repeating these processing steps the number of times decided in the initialization, it is possible for image capture devices to sequentially photograph images one at a time. FIG. 10 is an illustration showing a timing chart when the image capture device [1] outputs a reset signal and then waits for S (that is, α=1) to start exposure and the image capture device [2] outputs a reset signal and then waits for 2S to start exposure. Thus, because, according to the present embodiment, image capture devices are accurately synchronized using pre-light emission as a trigger, it is possible for image capture devices to sequentially capture a series of images one at a time.

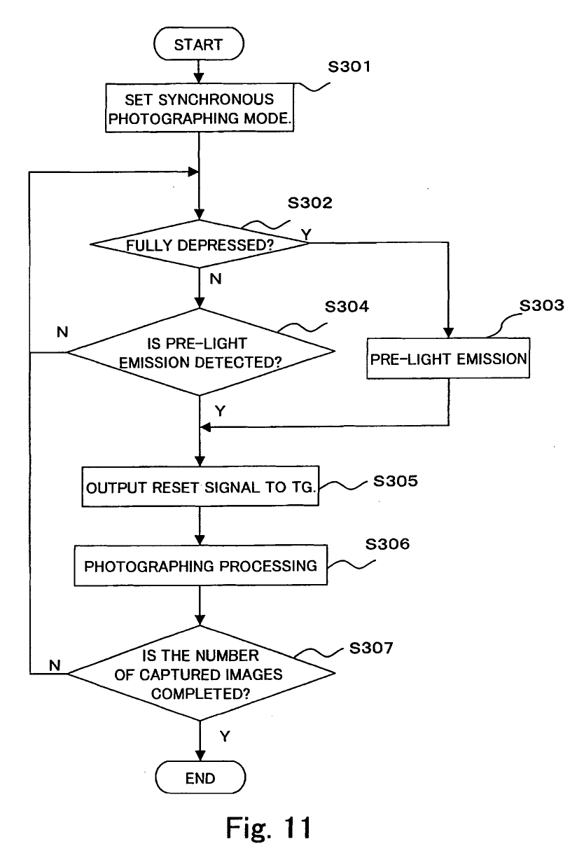

Furthermore, as still another modification of the present embodiment, it is possible to set all image capture devices in the same operation mode, hereafter referred to as synchronous photography mode, instead of a method of setting each of the above image capture devices to either of the main device mode and auxiliary device mode as described above. In this mode, when the shutter button of any image capture device is fully depressed, the image capture device performs pre-light emission and outputs a reset signal to its own timing generator and other image capture devices detect the pre-light emission and output reset signals to their own timing generators. Hereafter, the operation procedure of each image capture device set to the synchronous photographing mode is further described by referring to the flowchart shown in FIG. 11.

First, an image capture device sets the synchronous photographing mode (S301). More specifically, initialization necessary for synchronous photography such as the number of captured images or whether or not a flash is used is performed in accordance with a user operation, and the user sets the image capture device to a predetermined place. The image capture device receives the synchronous photographing mode setting operation input by the user and derives the light quantity for pre-light emission, which becomes a trigger of the output of a reset signal in accordance with the luminance of an object and derives the threshold voltage value Vₛ necessary for detection of pre-light emission. Moreover, when completing each setting necessary for the synchronous photographing mode, the image capture device executes AE/AF processing to enter a standby mode.

Thereafter, when the shutter button is fully depressed (determination result in S302 is affirmative “Y”), the image capture device performs pre-light emission (S303) and outputs a reset signal to its own timing generator of(S305). However, when the shutter button is not fully depressed (determination result in S302 is negative “N”) and the pre-light emission of other image capture device is detected (determination result in S304 is affirmative “Y”), the image capture device outputs a reset signal to its own timing generator (S305).

When the reset signal is output to the timing generator, the image capture device performs photography processing (S306). When the number of captured images specified in initialization is not completed (determination result in S307 is negative “N”), processings in and after S302 are continued. When the specified number of captured images have been completed (determination result in S307 is affirmative “Y”), the image capture device completes the synchronous photography mode processing.

When using a method of setting all image capture devices to the same operation mode instead of a method of setting each image capture device to either of the main device mode and auxiliary device mode, a user can begin synchronous photographing by only selecting any image capture device and fully depressing the shutter button of the image capture device. It is also possible to continue photography while the user fully depresses the shutter button of any image capture device without setting the number of images to be captured during initialization.

As still another modification, an example will be described in which a plurality of image capture devices continue synchronous photography and one image capture device performs flash emission every time an image is captured in a predetermined sequence (hereafter referred to as simultaneous continuous flash photographing mode). In the simultaneous continuous flash photographing mode, the following may occur. That is, to charge the power required to emit a flash, such as pre-light emission flash, a charge time which differs between image capture devices is required. Therefore, when a plurality of image capture devices sequentially perform photography followed by flash emission in a predetermined sequence in the simultaneous continuous flash photographing mode, it may in some instances be necessary to wait until the next image is captured when the charging of an image capture device assigned to the sequence of flash emission is not completed even though the other image capture devices are completely charged. Therefore, in the present modification, image capture devices which complete charge of the electric energy necessary for flash emission sequentially perform pre-light emission and image capture devices are synchronized as described above to simultaneously perform flash photography.

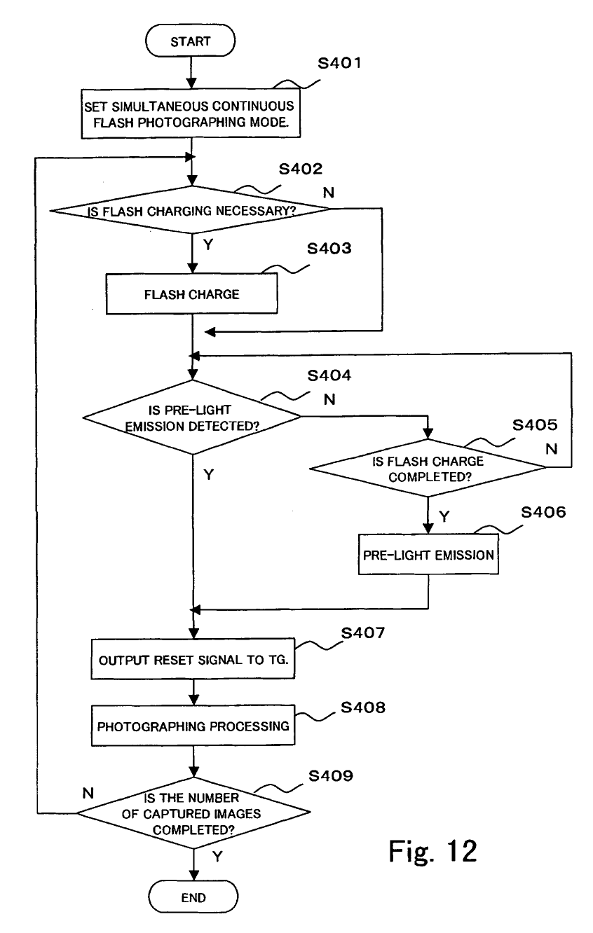

Hereafter, the processing procedure of the image capture device 10 in the simultaneous continuous flash photographing mode is described by referring to the flowchart in FIG. 12.

First, the image capture device 10 enters the simultaneous continuous flash photographing mode (S401). More specifically, the image capture device 10 sets various photography parameters necessary for operations in the simultaneous continuous flash photographing mode, such as photographing interval and the number of images to be captured, based on user input. Furthermore, the image capture device 10 receives the setting operation of the simultaneous continuous flash photographing mode from the user and derives the light quantity of pre-light emission serving as a trigger of output of a reset signal in accordance with the luminance of an object and derives the threshold voltage value Vₛ required to detect the pre-light emission. Furthermore, when each setting necessary for the synchronous photographing mode is completed, the image capture device 10 executes the AE/AF processing.

Furthermore, when the image capture device 10 requires flash charge (determination result in S402 is affirmative “Y”), it starts flash charge (S403) and then starts the operation in S404 and when flash charge is unnecessary, starts the operation in S404. Then, when flash charge is completed (determination result in S405 is affirmative “Y”) without detecting pre-light emission by other image capture device (determination result in S404 is negative “N”), the image capture device 10 performs pre-light emission (S406) and at the same time, outputs a reset signal to the timing generator 40 (S407).

When the image capture device 10 detects pre-light emission by other image capture device (determination result in S404 is affirmative “Y”) before flash charge is completed and pre-light emission is performed, the device 10 outputs a reset signal to the timing generator 40 by using detection of the pre-light emission as a trigger (S407).

When the reset signal is output to the timing generator 40, the image capture device 10 performs photographing processing (S408) and, moreover, when the specified number of captured images is not completed during initialization (determination result in S409 is negative “N”), continues processing in and after S402, but when the specified number of images have been captured (determination result in S409 is affirmative “Y”), completes the simultaneous continuous flash photographing mode processing.

Thus, because image capture devices completing flash charge sequentially perform pre-light emission and simultaneously perform flash photography, delay in image capturing resulting from flash charge requirements can be decreased, and it is possible to realize higher-speed simultaneous continuous photography. Moreover, because image capture devices are synchronized for every photography operation by using emission of pre-flash light as a trigger, it is possible to decrease the time required to shift between image capture devices or flash emission.

What is claimed is:

1. An image capture device including a timing generator that outputs a sync signal and a control circuit that controls photographing processing in accordance with the sync signal, comprising:
a detection circuit that detects a luminance change of an object; and
a reset circuit that outputs a reset signal to the timing generator in accordance with detection of the luminance change to adjust the output timing of the sync signal.

2. An image capture device according to claim 1, wherein
the detection circuit decides a threshold luminance in accordance with the luminance of an object under constant illumination and outputs an output command signal to the reset circuit when the luminance of the object exceeds the threshold luminance, and
the reset circuit outputs a reset signal in accordance with the output command signal.

3. The image capture device according to claim 1, wherein
the detection circuit detects the luminance change of the object by detecting pre-light emission of a small quantity of light emitted by another image capture device before main light emission for photographing illumination is started.

4. The image capture device according to claim 1, wherein
the device includes an automatic flash control circuit that emits a flash, receives the light reflected by an object by a light receiving device, and stops emission of the flash when the amount of light received by the light receiving device reaches a predetermined value, and
the detection circuit detects the luminance change of the object in accordance with the amount of light received by the light receiving device.

5. The image capture device according to claim 1, wherein
the sync signal is a vertical sync signal that drives a solid-state image capture element that vertically transfers a video signal generated by photoelectric-converting incoming light.

6. The image capture device according to claim 1, comprising
a flash circuit that performs pre-light emission of a small amount of light to an object prior to the start main light emission for illuminating the object, wherein
the reset circuit outputs a reset signal in accordance with pre-light emission performed by the flash circuit when the flash circuit performs pre-light emission.

7. The image capture device according to claim 6, wherein
the flash circuit performs pre-light emission in accordance with completion of charging of the power required to emit a flash.

8. An image capture device including a timing generator that outputs a sync signal and a control circuit that controls photographing processing in accordance with the sync signal, comprising:
a flash circuit that performs pre-light emission of a small amount of light to an object prior to the start main light emission for illuminating the object; and
a reset circuit that outputs a reset signal to the timing generator in accordance with the pre-light emission and adjusts the output timing of the sync signal.

9. An image capture system comprising at least two image capture devices respectively having a timing generator that outputs a sync signal and a control circuit that controls an exposure period in accordance with the sync signal, in which one image capture device functions as a main device and another image capture device functions as an auxiliary device, wherein
the main device includes a flash circuit that performs pre-light emission of a small amount of light to an object prior to the start main light emission for illuminating the object and a reset circuit that outputs a reset signal to the timing generator of the reset circuit in accordance with the pre-light emission to adjust the output timing of the sync signal,
the auxiliary device includes a detection circuit that detects pre-light emission to be applied to the object performed by the main device and a reset circuit that outputs a reset signal to the timing generator of the auxiliary device in accordance with detection of the pre-light emission to adjust the output timing of the sync signal, and
sync signals output from the timing generators of the image capture devices are synchronized.

10. A synchronizing method in which an image capture device including a timing generator that outputs a sync signal and a control circuit that controls photographing processing in accordance with the sync signal is synchronized with another image capture device, comprising:
a detection step for a detection circuit to detect the luminance change of an object; and
a first adjustment step for a reset circuit to output a reset signal to the timing generator in accordance with the detection of the luminance change to adjust the output timing of the sync signal.

11. The synchronizing method according to claim 10, wherein
in the detection step, threshold luminance is decided in accordance with the luminance of an object under constant illumination and an output command signal is output to the reset circuit when the luminance of the object exceeds the threshold luminance, and
in the first adjustment step, a reset signal is output in accordance with the output command signal.

12. The synchronizing method according to claim 11, comprising:
a detection step of detecting pre-light emission of a small amount of light performed before a flash circuit performs main light emission during a photographing operation; and
a second adjustment step for the reset circuit to output a reset signal to the timing generator in accordance with the detection of pre-light emission and to adjust the output timing of the synch signal.
